(19) United States
(12) Patent Application Publication
(10) Pub. No.: US 2022/0240433 A1
(43) Pub. Date: Aug. 4, 2022

(54) METHOD FOR DETERMINING AND PROVIDING AN APPLICATION SCHEME FOR PESTICIDES

(71) Applicant: BASF Agro Trademarks GmbH, Ludwigshafen am Rhein (DE)

(72) Inventors: Holger HOFFMANN, Langenfeld (DE); Wagner PASOLIUS WEXEL, Köln (DE); Umit Baran ILBASI, Sao Paulo (BR); Bjoern KIEPE, Köln (DE); Hiran ZANI, Sao Paulo (BR); Fabrisio DE EUSTAQUIO RESENDE, Sao Paulo (BR); Mauricio LOPES AGNESE, Köln (DE); Samyra BALDASSIN, Sao Paulo (BR); Andre SALVADOR, Avare (BR)

(21) Appl. No.: 17/626,687

(22) PCT Filed: Jul. 13, 2020
(86) PCT No.: PCT/EP2020/069785

§ 371 Date: Jan. 12, 2022

(30) Foreign Application Priority Data
Jul. 15, 2019 (EP) 19186344.8

(51) Int. Cl. A01B 79/00; A01B 79/02; A01C 21/00; A01N 25/00; G06F 16/2457

(52) U.S. Cl. CPC A01B 79/005; A01B 79/02; G06F 16/24578; A01N 25/00; A01C 21/005

(57) ABSTRACT

Method for determining and providing an application scheme for pesticides, comprising the following steps: providing agricultural crop data (S10) comprising information about an agricultural crop species sown or planned to sow in a field; providing application time data (S20) comprising information about at least one planned application time of applying pesticides in the field; providing weed and/or pathogen specifier data (S30) comprising information about at least one weed or pathogen specifier present or expected in the field; performing a database search in a pesticide product database (S50) at least based on the provided agricultural crop data, the provided application time data, the provided weed and/or pathogen specifier data and determining the pesticide products matching the agricultural crop and the application time and one of the weed or pathogen specifiers, wherein the pesticide product database comprises information about a plurality of pesticide products, and wherein the information about the pesticide products comprises at least information about an application area of each pesticide product, an active ingredient of each pesticide product and a suitable application time for each pesticide product; ranking generated application schemes (S70), wherein the different application schemes (S60) are generated by combining the determined pesticide products in such a way that all weeds and/or pathogen indicators are covered; wherein the step of ranking is based on one or more of the following statistics per application scheme: the number of pesticides per application scheme; the number of leading or priority weeds and/or pathogens covered with an efficacy above a defined threshold, wherein in an example, the defined threshold is above 80% and wherein in an example this defined threshold represents the most weighted statistic per application scheme; the number of all weeds and/or pathogens covered with a efficacy above a defined thresholds; maximum efficacy achieved across weeds and/or pathogens by a given pesticide; the fraction of pesticides in the application scheme of known preferred usage at the time of application; the achieved efficacy sum of all pesticides in the application scheme for leading or priority weeds and/or pathogens; the achieved efficacy sum of all pesticides in the application scheme for all weeds and/or pathogens; if applicable, the average expected control of residual efficacy duration in soil; and/or an index accounting for repeating the mode of action and/or active ingredient compared to previous applications.

### FIELD OF THE INVENTION

The present invention relates to a method for determining and providing an application scheme for pesticides; the use of such an application scheme for providing control data for controlling an agricultural equipment; and to the use of a pesticide product database in a method for determining and providing an application scheme for pesticides.

### BACKGROUND OF THE INVENTION

Using more than one pesticide product in one application, i.e. by mixing two or more pesticide products in a tank, is a routine procedure, which can reduce the cost of application, enhance the activity of certain products, and widen the range of treatments in a single application.

However, in practice a user faces several uncertainties when deciding which pesticide products can be mixed in a tank and can be applied in a single application. One of the uncertainties is given by the fact that for each pesticide product an allowed/applicable application time has to be considered, if post emergence also with respect to the given crop trait. Moreover, when mixing pesticide products, it has also to be considered for which agricultural crops, varieties/traits, weeds and/or pathogens a respective pesticide product can be used in a most efficient manner. The goal in this respect is to select a pesticide product mix and doses against a present or an expected weed/pathogen spectrum, with sufficient efficacy but lowest environmental and economic impact. However, the mentioned factors lead to a large number of possible combinations of pesticide products across a season when considering the combinations of pesticide products at a given application time and rotating these across the season.

In view of this, it is found that a further need exists to simplify such a selection of pesticide products when using in one application, i.e. in one tank mixture.

### SUMMARY OF THE INVENTION

In the view of the above, it is an object of the present invention to provide a method for determining and providing an application scheme for pesticides, which can be easily applied by a user and by which a respective pesticide mix recommendation is provided to a user. These and other objects, which become apparent upon reading the following description, are solved by the subject matter of the independent claims. The dependent claims refer to preferred embodiments of the invention.

According to a first aspect of the present disclosure, a method for determining and providing an application scheme for pesticides is provided, comprising at least the following steps:
Providing/receiving agricultural crop data comprising information about an agricultural crop species sown or planned to sow in a field;
Providing/receiving application time data comprising information about at least one planned application time of applying pesticides in the field;
providing weed and/or pathogen specifier data comprising information about at least one weed or pathogen specifiers present or expected in the field;
providing/receiving a pesticide product database comprising information about a plurality of pesticide products, wherein the information about the pesticide products comprises at least information about an application area of each pesticide product, an active ingredient of each pesticide product and a suitable application time for each pesticide product;
performing a database search in the pesticide product database at least based on the provided agricultural crop data, the provided application time data, the provided weed and/or pathogen specifier data and determining the pesticide products matching the agricultural crop and the application time and at least one of the weed or pathogen specifiers;
generating different application schemes by combining the determined pesticide products in such a way that all weeds and/or pathogen indicators are covered; and
ranking the generated application schemes at least according to the number of pesticide products per application scheme, wherein it is preferred that the generated application schemes are ranked in view of further parameters/statistics/variables.

According to a second aspect of the present disclosure, a method for determining and providing an application scheme for pesticides, comprising the following steps:
providing agricultural crop data comprising information about an agricultural crop species sown or planned to sow in a field;
providing application time data comprising information about at least one planned application time of applying pesticides in the field;
providing weed and/or pathogen specifier data comprising information about at least one weed or pathogen specifier present or expected in the field;
performing a database search in a pesticide product database at least based on the provided agricultural crop data, the provided application time data, the provided weed and/or pathogen specifier data and determining the pesticide products matching the agricultural crop and the application time and one of the weed or pathogen specifiers, wherein the pesticide product database comprises information about a plurality of pesticide products, and wherein the information about the pesticide products comprises at least information about an application area of each pesticide product, an active ingredient of each pesticide product and a suitable application time for each pesticide product;
ranking generated application schemes, wherein the different application schemes are generated by combining the determined pesticide products in such a way that all weeds and/or pathogen indicators are covered;
wherein the step of ranking is based on one or more of the following statistics per application scheme:
   a) the number of pesticides per application scheme;
   b) the number of leading or priority weeds and/or pathogens covered with an efficacy above a defined threshold, wherein in an example, the defined threshold is above 80% and wherein in an example this defined threshold represents the most weighted statistic per application scheme;
   c) the number of all weeds and/or pathogens covered with an efficacy above a defined thresholds;
   d) maximum efficacy achieved across weeds and/or pathogens by a given pesticide;
   e) the fraction of pesticides in the application scheme of known preferred usage at the time of application;
   f) the achieved efficacy sum of all pesticides in the application scheme for leading or priority weeds and/or pathogens;
   g) the achieved efficacy sum of all pesticides in the application scheme for all weeds and/or pathogens;
   h) if applicable, the average expected control of residual efficacy duration in soil; and/or
   i) an index accounting for repeating the mode of action and/or active ingredient compared to previous applications.

In an example, all above-mentioned statistics per application scheme are used for the step of ranking the application schemes; preferably at least two of the above-mentioned statistics are used for the step of ranking the application schemes; preferably at least three of the above-mentioned statistics are used for the step of ranking the application schemes; preferably at least four of the above-mentioned statistics are used for the step of ranking the application schemes; preferably at least five of the above-mentioned statistics are used for the step of ranking the application schemes; preferably at least six of the above-mentioned statistics are used for the step of ranking the application schemes; preferably at least seven of the above-mentioned statistics are used for the step of ranking the application schemes and/or preferably at least eight of the above-mentioned statistics are used for the step of ranking the application schemes.

In an example, the present invention provides a solution by which a ranking of application schemes based on minimum required information can be provided, in particular without the need to be informed about all the details of each pesticide product, e.g. the active ingredients of each pesticide product, their indicators and their allowed application times. Such an application scheme comprises a list of pesticide products, which can be combined in a mixture for an application, wherein by means of the application scheme all specified weeds and/or pathogens are covered by the provided mixture only comprising pesticide products that are allowed to be used within the provided application time(s).

The provided application time of applying pesticides in the field can be a date or a time window, i.e. the date or time window when it is planned to spread pesticides in a certain field. The agricultural crop species sown or planned to sow in a field can be provided by a common or scientific name of the crop or by any other identifier, e.g. a product serial number or the like. A weed or pathogen specifiers present or expected in the field can also be provided by a common or scientific name of a weed species/genius, EPPO-Code (https://gd.eppo.int/), or also by any other identifier, e.g. an identification number or the like. In this respect, it is only important that such information can be used directly or indirectly for the database search in the pesticide product database. Finally, the term performing a database search is to be understood broadly and already encompasses the input/providing of the database search queries in the pesticide product database. In a further aspect of the present disclosure, the step of ranking the generated application schemes according to the statistics may be substituted by the step of outputting/providing/displaying the ranked generated application schemes according to the number of pesticide products per application scheme.

The pesticide product database comprises information about the active ingredient(s) of each pesticide product and a suitable application time for each pesticide product and the application area of each pesticide product, e.g. whether a pesticide product is used against a weed or pathogen and/or against which weeds or pathogens a pesticide product is usually used. Such a pesticide product database may cover all or most of the common pesticide products or may be limited to the pesticide products of a certain provider. Moreover, it is also possible to limit the pesticide product database to pesticide products allowed in a respective jurisdiction. The pesticide product database might be provided by a third party. However, it is also possible that a user creates his tailored pesticide product database by scanning the labels of each pesticide product he intends to use and by acquiring the respective information about each pesticide product from supplier databases. By means of the latter, it is also possible that a user supplements a pesticide product database adding information about further pesticide products. Notably, the term pesticide according to the present invention is to be understood broadly and may be any herbicide, fungicide, insecticide or mixtures thereof which may be used against a weed and/or pathogen and the like. Moreover, the term pathogen is understood as any living organism, which can cause harm to the plant or can negatively impact the growth or the health of a plant. Pathogens include, but are not limited to, fungi, bacteria, viruses, insect pests, arachnids, nematodes, mollusks, and rodents. In one preferred embodiment, the pathogen is a fungi. In another preferred embodiment, the pathogen is an insect pest.

A generated application scheme according to the present invention can be any visualized or none-visualized data/information providing a combination of the determined pesticide products matching the provided agricultural crop and the application time and either one weed specifier or one pathogen specifier, wherein the determined pesticide products are combined in an application scheme in such a way that all weed and pathogen specifiers are covered. In the step of generating the application schemes, all or a predefined number of application schemes are provided by combining the determined pesticide products in such a way that by each combination of the pesticide products all weed and pathogen specifiers are covered. Subsequently, these generated application schemes are ranked, in particular in view of the number of pesticide products required to cover all weed and pathogen specifiers. The ranked list of application schemes can be provided in a visualized and/or none-visualized form, e.g. by means of a data set which can be further processed by a data processing system or by means of a data processing system comprising a display.

As a result, the present invention provides a solution by which a user receives a ranked number of application schemes covering all weed and pathogen specifiers matching the provided application time(s). Thus, a simplified and more reliable determination of a pesticide product mix can be provided by applying the present invention.

It is preferred that the agricultural crop data is provided by means of a user interface or by a data processing unit. For example, a respective user interface can be provided by a data processing system, e.g. a computer, a smartphone, a tablet or the like, comprising respective inputting means with which a user can provide the respective information. However, it is also possible that the agricultural crop data is provided by a data processing unit, e.g. a data processing unit of a sowing machine used to sow the agricultural crop in the field or any other data processing unit in which the agricultural crop data is stored.

Preferably, the weed and/or pathogen specifier is provided by means of a user interface or by means of an image recognition of the field. Also here, a respective user interface can be provided by a data processing system, e.g. a computer, a smartphone, a tablet or the like, comprising respective inputting means with which a user can provide the respective information. However, it is also possible to establish a more or less automated process by using data derived from image recognition of the respective field, wherein these data can also be provided by a third party analyzing respective images, e.g. satellite or drone images.

It is further preferred that an application scheme further comprises information about the dosage ranges for each pesticide product and thresholds, wherein the thresholds may be pre-defined or entered manually, and wherein the predefined thresholds may also be combined with a user defined variable threshold. In this respect, the provided information about the dosage ranges for each pesticide product may also comprise different dosage ranges for each pesticide product in view of the crop growth stage and/or an infestation stage. Moreover, in particular, if a mixture according to an application scheme is provided by a third party, it is further preferred that prior or during application, the mixture is validated, e.g. by means of a barcode, RFID or the like which is provided on the tank mix and which can be scanned by corresponding read-out means such that the actual mixture can be compared with the used application scheme.

Preferably, the method further comprises the step of providing an application map by combining field data and an application scheme. The field data may comprise information about the geographical details, e.g. boundaries, and specifics of the field, the arrangement and the crop growth stage, and/or the distribution/position of the weeds and/or pathogens. By providing such field data and combining it with an application scheme, a spatially resolved application map can be provided comprising information about where and which dosage should be spread in the field. Notably, the field data can be provided by a user interface or by means of an image recognition of the respective field. Also here, the respective images can be provided by a satellite or a drone system. In addition, the field data can be provided by a third party, e.g. a service provider analyzing the respective images and application scheme.

Preferably, the pesticide product information further comprises information about the efficacy of the pesticide products against a weed and/or pathogen and the step of ranking the generated application schemes is further based on the efficacy of the pesticide products against a weed and/or pathogen. Thereby, not only the number of pesticide products which are needed to cover all weed and or pathogen specifiers can be used for ranking the generated application schemes, but also the efficacy of the pesticide products. The efficacies can be taken from commercial or public available databases and/or expert revisions, wherein if an expert revised efficacy is at hand, such data is preferred. Moreover, the efficacies can be weighted depending on the respective application, e.g. burn down, second burn down, around planting, emergence, harvesting. In this respect, efficacies may be either averaged across single efficacies and further weighted by the number of pesticide products in application scheme. By means of such a ranking the highest efficacy for each weed and/or pathogen specifier can be found potentially with a minimum number of pesticide products. In more detail, the ranking may be based on the following statistics per application scheme:
1. the number of pesticides per application scheme;
2. the number of leading or priority weeds and/or pathogens covered with an efficacy above a defined threshold, wherein in an example, the defined threshold is above 80%;
3. the number of all weeds and/or pathogens covered with an efficacy above a defined thresholds;
4. maximum efficacy achieved across weeds and/or pathogens by a given pesticide;
5. the fraction of pesticides in the application scheme of known preferred usage at the time of application;
6. the achieved efficacy sum of all pesticides in the application scheme for leading or priority weeds and/or pathogens;
7. the achieved efficacy sum of all pesticides in the application scheme for all weeds and/or pathogens;
8. if applicable, the average expected control of residual efficacy duration in soil; and/or
9. an index accounting for repeating the mode of action and/or active ingredient compared to previous applications.

These statistics may be used to calculate ranking values, which may be attributed to each application scheme. In this process, the number of pesticides per application scheme (i.e. number 1 above) may be used to penalize for a large number of pesticides per application scheme, i.e. resulting in a lower ranking value. Similarly, an index accounting for repeating the mode of action and/or active ingredient compared to previous applications may be used to penalize for repeating the mode of action and/or active ingredient compared to previous applications, which may result in a lower ranking value. In contrast, statistics related to efficacy are used to favor those application scheme(s) of higher efficacy, resulting in larger ranking values. Statistics and resulting ranking values may be used to rank the application schemes. For this purpose, statistics and resulting ranking values may be used for ranking stepwise in a determined order. In an example, ranking can be done first by ranking with regard to the number of leading or priority weeds and/or pathogens covered with an efficacy above a defined threshold (i.e. number 2 above), thereafter ranking application scheme of same rank according to an index accounting for repeating the mode of action and/or active ingredient compared to previous applications, thereafter ranking by other statistics or ranking values.

In a further example, in a first step a first/rough ranking may be done in view of the statistics mentioned-above under the number 2 (i.e. the number of leading or priority weeds and/or pathogens covered with an efficacy above a defined threshold) outputting a first/rough ranking. Subsequently, the ranking/result of this first/rough ranking is more precisely ranked in a second step, in view of one or more of the statistics mentioned-above under the numbers 1 (i.e. the number of pesticides per application scheme) and 3 to 9 (i.e. an index accounting for repeating the mode of action and/or active ingredient compared to previous applications).

In a further example, in a first step a first/rough ranking may be done in view of the statistics mentioned-above under the numbers 3 (i.e. the number of all weeds and/or pathogens covered with an efficacy above a defined thresholds) outputting a first/rough ranking. Subsequently, the ranking/result of this first/rough ranking is more precisely ranked in a second step, in view of one or more of the statistics mentioned-above under the numbers 1 (i.e. the number of pesticides per application scheme), 2 and 4 to 9 (i.e. an index accounting for repeating the mode of action and/or active ingredient compared to previous applications).

In yet a further example, in a first step a first/rough ranking may be done in view of the statistics mentioned-above under the number 1 (i.e. the number of pesticides per application scheme) outputting a first/rough ranking. Subsequently, the ranking/result of this first/rough ranking is more precisely ranked in a second step, in view of one or more of the statistics mentioned-above under the numbers 2 (i.e. the number of leading or priority weeds and/or pathogens covered with an efficacy above a defined threshold) to 9 (i.e. an index accounting for repeating the mode of action and/or active ingredient compared to previous applications).

Notably, the above-mentioned statistics relate to preferred parameters/statistics which are considered/used for ranking the generated application schemes. However, further parameters/statistics/information may be considered/used for ranking the generated application schemes.

It is further preferred that the pesticide product information further comprises information about detrimental effects when mixing specific pesticide products and that the step of ranking the generated application schemes is further based on the detrimental effects when mixing specific pesticide products. Thereby, not meaningful pesticide product combinations or pesticide product combinations having antagonistic effects can either be removed or listed at the end of the generated application schemes depending on the respective antagonistic effect.

It is preferred that the provided agricultural crop data further comprises information about the actually observed or modelled crop growth stage and the sowing date and that the pesticide product information further comprises information about the efficacy of the pesticide products in view of crop growth stage and the sowing date; and that the step of ranking the generated application schemes is further based on the efficacy of the pesticide products in view of crop growth stage or the sowing time. In particular, the efficacies of each pesticide product can be provided for the different crop growth stages, e.g. seed, initial, juvenile, mature/flowering, such that a respective efficacy can be taken into account in view of the actual crop growth stage.

Preferably, the provided agricultural crop data further comprises information about the past agricultural crop grown in the field and/or the next agricultural crop planned to be grown in the field; and that the step of ranking the generated application schemes is further based on information about the past agricultural crop grown in the field and/or the next agricultural crop planned to be grown in the field. Thereby, the agricultural crop rotation can be considered when ranking the generated application schemes and a repeated application of the same pesticide product(s) or the same mode of action can be avoided. Therefore, combinations including a repeated application of pesticide products with the same mode of action and/or a repeated application of the same pesticide products can be a ranked lower, wherein a repeated application of the same pesticide products is ranked lower for avoiding resistances than a repeated mode of action.

It is preferred that the weed and/or the pathogen specifier data further comprises information about the weed or pathogen growth stage; and that the pesticide product information further comprises information about the efficacy in view of the weed or pathogen growth stage; and that the step of ranking the generated application schemes is further based on the efficacy of the pesticide products in view of the weed or pathogen growth stage. Thereby, it is possible to further individualize an application scheme to the actual situation in the field. The information about the weed or pathogen growth stage can be provided by a user interface or by means of an image recognition of the respective field. Also here, the respective images can be provided by a satellite or a drone system. In addition, the information about the weed or pathogen growth stage can be provided by a third party, e.g. a service provider analyzing the respective images.

It is further preferred that for the application time(s) weather data is obtained and the pesticide product information further comprises information about the weather requirements for applying a pesticide product and/or the efficacy of the pesticide product in view of the weather conditions and wherein the step of ranking the generated application schemes is further based on the weather requirements for applying a pesticide product and/or the efficacy of the pesticide product in view of the weather data. Notably, the weather data can be provided by a third party, e.g. a service provider, or by on-side sensors.

Preferably, the weed and/or pathogen specifier data further comprises information about a treatment priority and that the step of ranking the generated application schemes is further based on the information about the treatment priority. By means of such a treatment priority information, it can be indicated which weeds and/or pathogens can be exceptionally harmful for the agricultural crop and should be treated with priority. For example, the priority information can be provided by a user interface or by means of an image recognition of the respective field. Also here, the respective images can be provided by a satellite or a drone system. In addition, the information about the treatment priority can be provided by a third party, e.g. a service provider analyzing the respective images.

It is preferred that the database search and/or the application schemes can be limited to preselected pesticide products. For example, a user may preselect pesticide products already available/stored such that these pesticide products can be used primarily.

Preferably, an application scheme comprises mixture instructions, including dosage of the pesticide products and information about useful or required additives to the mixture. For example, minimum, maximum and the recommended dose rate (L/ha) for a herbicide and additive, so herbicides and additives have both a dosing logic, can be provided. Moreover, also the detailed tank mix as recipe for a specific field can be provided (e.g. herbicide1 x L, herbicide2 x L, additive1 z L, water 3000 L). Thereby, a mixture of the pesticide products mentioned in an application scheme can be simplified and failures when mixing the pesticide products can be avoided, e.g. wrong mixing orders, too short stirring times and so on.

Finally, it is preferred that the method further comprises the step of generating control data configured to be used in an agricultural equipment, wherein the control data is based on the highest ranked application scheme or an application scheme selected by a user. For example, a user may select an application scheme depending on his own considerations or priorities by selecting a respective application scheme by respective inputting means of a data processing unit, e.g. a computer, a tablet, a smartphone or the like.

The present invention also relates to the use of an application scheme received according to a method for determining and providing an application scheme for pesticides as described above for providing control data for controlling an agricultural equipment. In this respect, the term agricultural equipment is to be understood broadly and refers to all machines, data processing units, vehicles, vessels or aircrafts, e.g. also mixing machines/systems for preparing a pesticide mixture, transportation and spraying machines for transporting and spraying the pesticide mixture to or in the field.

The present invention also relates to the use of a pesticide product database in a method for determining and providing an application scheme for pesticides as described above, wherein the pesticide product database comprising information about a plurality of pesticide products, and wherein the information about the pesticide products comprises at least information about an application area of each pesticide product, an active ingredient of each pesticide product and a suitable application time for each pesticide product. Also here, the term application area is to be broadly understood and comprises any information about an application information of a pesticide product database. Moreover, it is also not required that all database entries are structured in the same manner.

Moreover, the present invention also relates to a system for determining and providing an application scheme for pesticides, comprising: at least one user interface configured to allow an user to input agricultural crop data, a weed and/or pathogen specifier and application time data; at least one memory unit comprising a pesticide product database comprising information about a plurality of pesticide products, and wherein the information about the pesticide products comprises at least information about an application area of each pesticide product, an active ingredient of each pesticide product and a suitable application time for each pesticide product; at least one processing unit configured to perform a database search in the pesticide product database at least based on the provided agricultural crop data, the provided application time data, the provided weed and/or pathogen specifier data and which determines the pesticide products matching the agricultural crop and the application time and one of the weed or pathogen specifiers; at least on processing unit configured to generate different application schemes by combining the determined pesticide products in such a way that all weeds and/or pathogen indicators are covered; at least one processing unit configured to rank the generated application schemes according to the number of pesticide products per application scheme. With respect to the system for determining and providing an application scheme for pesticides, it is referred to the above-mentioned explanations with respect to the method, which also apply with respect to the system.

Finally, the present invention also relates to a computer program or computer program element configured to execute the above explained method, on an appropriate apparatus or system.

The computer program element might therefore be stored on a computer unit, which might also be part of an embodiment. This computing unit may be configured to perform or induce performing of the steps of the method described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the invention covers both, a computer program that right from the beginning uses the invention and computer program that by means of an update turns an existing program into a program that uses invention.

Further on, the computer program element might be able to provide all necessary steps to fulfill the procedure of an exemplary embodiment of the method as described above.

According to a further exemplary embodiment of the present invention, a computer readable medium, such as a CD-ROM, USB stick or the like, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

In the following, a non-exhaustive list of non-limiting examples is provided as embodiments A to R. Any one or more of the features of these examples may be combined with any one or more features of another example, embodiment, or aspect described herein.
A. Method for determining and providing an application scheme for pesticides, comprising the following steps:
   providing agricultural crop data (S10) comprising information about an agricultural crop species sown or planned to sow in a field;
   providing application time data (S20) comprising information about at least one planned application time of applying pesticides in the field;
   providing weed and/or pathogen specifier data (S30) comprising information about at least one weed or pathogen specifier present or expected in the field;
   providing a pesticide product database (S40) comprising information about a plurality of pesticide products, and wherein the information about the pesticide products comprises at least information about an application area of each pesticide product, an active ingredient of each pesticide product and a suitable application time for each pesticide product;
   performing a database search in the pesticide product database (S50) at least based on the provided agricultural crop data, the provided application time data, the provided weed and/or pathogen specifier data and determining the pesticide products matching the agricultural crop and the application time and one of the weed or pathogen specifiers;
   generating different application schemes (S60) by combining the determined pesticide products in such a way that all weeds and/or pathogen indicators are covered;
   ranking the generated application schemes (S70) according to the number of pesticide products per application scheme.
B. Method according to embodiment A, wherein the agricultural crop data is provided by means of a user interface or by a data processing unit.
C. Method according to any one of embodiments A or B, wherein the weed and/or pathogen specifier is provided by means of a user interface or by means of an image recognition of the field.
D. Method according to any one of the preceding embodiments A to C, wherein an application scheme further comprises information about the dosage ranges for each pesticide product and thresholds.
E. Method according to any one of the preceding embodiments, wherein the method further comprises the step of providing an application map by combining field data and an application scheme.
F. Method according to any one of the preceding embodiments, wherein
   the pesticide product information further comprises information about the efficacy of the pesticide products against a weed and/or pathogen; and wherein
   the step of ranking the generated application schemes is further based on the efficacy of the pesticide products against a weed and/or pathogen.
G. Method according to any one of the preceding embodiments, wherein
   the pesticide product information further comprises information about detrimental effects when mixing specific pesticide products; and wherein
   the step of ranking the generated application schemes is further based on the detrimental effects when mixing specific pesticide products.
H. Method according to any one of the preceding embodiments, wherein
   the provided agricultural crop data further comprises information about the crop growth stage or the sowing date; and wherein
   the pesticide product information further comprises information about the efficacy of the pesticide products in view of crop growth stage or the sowing date; and wherein
   the step of ranking the generated application schemes is further based on the efficacy of the pesticide products in view of crop growth stage or the sowing time.
I. Method according to any one of the preceding embodiments, wherein
   the provided agricultural crop data further comprises information about the past agricultural crop grown in the field and/or the next agricultural crop planned to be grown in the field; and wherein
   the step of ranking the generated application schemes is further based on information about the past agricultural crop grown in the field and/or the next agricultural crop planned to be grown in the field.
J. Method according to any one of the preceding embodiments, wherein
   the weed and/or the pathogen specifier data further comprises information about the weed or pathogen growth stage; and wherein
   the pesticide product information further comprises information about the efficacy in view of the weed or pathogen growth stage; and wherein
   the step of ranking the generated application schemes is further based on the efficacy of the pesticide products in view of the weed or pathogen growth stage.
K. Method according to any one of the preceding embodiments, wherein
   the weed and/or pathogen specifier data further comprises information about a treatment priority; and wherein
   the step of ranking the generated application schemes is further based on the information about the treatment priority.
L. Method according to any one of the preceding embodiments, wherein the database search and/or the application schemes are limited to preselected pesticide products.
M. Method according to any one of the preceding embodiments, wherein an application scheme comprises mixture instructions about the dosage of the pesticide products and information about useful or required additives to the mixture.
N. Method according to any one of the preceding embodiments, wherein the method further comprises the step of generating control data configured to be used in an agricultural equipment, wherein the control data is based on the highest ranked application scheme or an application scheme selected by a user.
O. Use of an application scheme received according to a method according to any one of embodiments A to N for providing control data for controlling an agricultural equipment.
P. Use of a pesticide product database in a method according to any one of embodiments A to N, wherein the pesticide product database comprising information about a plurality of pesticide products, and wherein the information about the pesticide products comprises at least information about an application area of each pesticide product, an active ingredient of each pesticide product and a suitable application time for each pesticide product.
Q. A system for determining and providing an application scheme for pesticides according to any one of embodiments A to N, comprising:
   at least one user interface configured to allow an user to input agricultural crop data, a weed and/or pathogen specifier and application time data;
   at least one memory unit comprising a pesticide product database comprising information about a plurality of pesticide products, and wherein the information about the pesticide products comprises at least information about an application area of each pesticide product, an active ingredient of each pesticide product and a suitable application time for each pesticide product;
   at least one processing unit configured to perform a database search in the pesticide product database at least based on the provided agricultural crop data, the provided application time data, the provided weed and/or pathogen specifier data and which determines the pesticide products matching the agricultural crop and the application time and one of the weed or pathogen specifiers;
   at least on processing unit configured to generate different application schemes by combining the determined pesticide products in such a way that all weeds and/or pathogen indicators are covered;
   at least one processing unit configured to rank the generated application schemes according to the number of pesticide products per application scheme.
R. A computer program element which when executed by a processor is configured to carry out the method of claim according to any of embodiments A to N.

### BRIEF DESCRIPTION OF THE DRAWINGS

In the following, the invention is described exemplarily with reference to the enclosed figure, in which

FIG. 1 is a schematic view of a method according to the preferred embodiment of the present invention;

FIG. 2 is an exemplary schematic input screen by which a user may provide the information required for performing a method according to the present invention;

FIG. 3 is an exemplary schematic output of a dose rate scheme;

FIG. 4 is an exemplary application map;

FIG. 5 is an exemplary tank mix receipt for the field shown in FIG. 4; and

FIG. 6 is a schematic view of a robotic vehicle acquiring imagery of a field.

### DETAILED DESCRIPTION OF EMBODIMENT

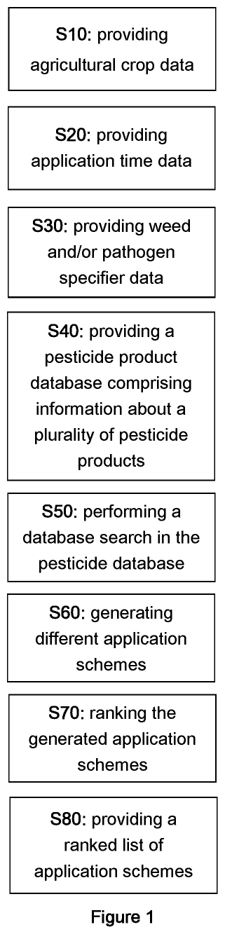

FIG. 1 is a schematic view of a method according to the preferred embodiment of the present invention. In the following, an exemplary order of the steps according to the present invention is explained. However, the provided order is not mandatory, i.e. all or several steps may be performed in a different order or simultaneously.

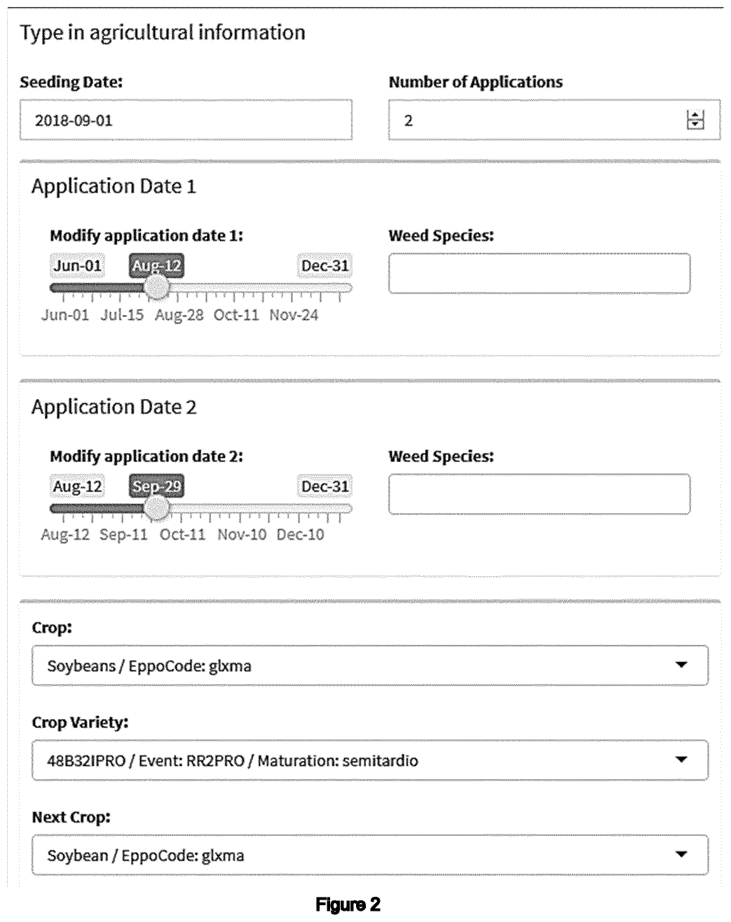

In a step S10, agricultural crop data comprising information about an agricultural crop species sown or planned to sow in a field is provided. For example, this information can be provided by means of a user interface (cf. FIG. 2) by which a user can provide a common or scientific name of the crop or any other identifier, e.g. a product serial number or the like. Such a user interface can be provided by a data processing system, e.g. a computer, a smartphone, a tablet or the like. Alternatively or in addition, the agricultural crop data may be provided by a data processing unit, e.g. a data processing unit of a sowing machine used to sow the agricultural crop in the field or any other data processing unit in which the agricultural crop data is stored (e.g. an ordering system used for ordering the respective agricultural crop). In this respect, it is only required, that the species and/or variety of the agricultural crop is known for the purpose of the present invention. However, in the preferred embodiment, additional information about the crop growth stage and/or the sowing date and/or information about the past agricultural crop grown in the field and/or the next agricultural crop planned to be grown in the field is provided, since such information can further be used for ranking the generated application schemes and/or for providing further information in an application scheme.

In a step S20, application time data comprising information about at least one planned application time of applying pesticides in the field is provided. Each application time can be provided as a date or a time window, i.e. the date or the time window when a user plans to spread pesticides in a certain field. This information can also be provided by means of a user interface by which a user could input the planned application time(s) (cf. FIG. 2). It is further preferred that for the application time(s) weather data is obtained. Notably, the weather data can be provided by a third party, e.g. a service provider, or by on-side sensors. Moreover, depending on the remaining time until the application time, it is possible to add the weather data at a later point in time and/or to include/update the weather data at a predetermined time interval before the application time.

In a step S30, weed and/or pathogen specifier data comprising information about a weed or pathogen specifier present or expected in the field are provided. The weed and/or pathogen specifier can be provided by means of a user interface or by means of an image recognition of the field. Also here, a respective user interface (cf. FIG. 2) can be provided by a data processing system, e.g. a computer, a smartphone, a tablet or the like, comprising respective inputting means with which a user can provide the respective information. A weed or pathogen specifiers present or expected in the field can be provided by a common or scientific name of a weed species/genius or also by any other identifier, e.g. an identification number or the like. In this respect, it is only important that such information can be used directly or indirectly for the database search in the pesticide product database. However, it is also possible to establish a more or less automated process by using data derived from image recognition of the respective field, wherein these data can also be provided by a third party analyzing respective images, e.g. satellite or drone images. In the preferred embodiment, additional information about a treatment priority and/or about the weed and/or pathogen growth stage is provided, since such information can further be used for ranking the application schemes and/or for providing further information in an application scheme.

In a step S40, a pesticide product database comprising information about a plurality of pesticide products is provided, wherein the information about the pesticide products comprises at least information about an application area of each pesticide product, an active ingredient of each pesticide product and a suitable application time for each pesticide product. Thus, the pesticide product database comprises information about the active ingredient(s) of each pesticide product and a suitable application time for each pesticide product and the application area of each pesticide product, e.g. whether a pesticide product is used against a weed or pathogen and/or against which weeds or pathogens a pesticide product is usually used. Such a pesticide product database may cover all or most of the common pesticide products or may be limited to the products of a certain provider. Moreover, it is also possible to limit the pesticide product database to pesticide products allowed in a respective jurisdiction. The pesticide product database might be provided by a third party. However, it is also possible that a user creates his tailored pesticide product database by scanning the labels of each pesticide product he intends to use and by acquiring the respective information about each pesticide product from supplier databases. By means of the latter, it is also possible that a user supplements a pesticide product database adding information about further pesticide products. Notably, a pesticide product according to the present invention can be any herbicide, fungicide, insecticide or mixtures thereof, i.e. the present invention is not limited to a specific kind of pesticide product.

In the preferred embodiment, the pesticide product database further comprises information with respect to the efficacy of the pesticide products against a weed and/or a pathogen, detrimental effects when mixing specific pesticide products, the efficacy of the pesticide products in view of crop growth stage or the sowing date, the efficacy in view of the weed or pathogen growth stage, the weather requirements for applying a pesticide product and/or the efficacy of the pesticide product in view of the weather conditions.

In a step S50, a database search in the pesticide database at least based on the provided agricultural crop data, the provided application time data, the provided weed and/or pathogen specifier data is performed and the pesticide products matching the agricultural crop and the application time and at least one of the weed or pathogen specifiers are determined. Thus, the output of step S50 are all pesticide products matching the agricultural crop and the application time and at least one of the weed or pathogen specifiers.

In a step S60, different application schemes are generated by combining the pesticide products determined in step S50 in such a way that in each combination, i.e. in each generated application scheme, all weed and/or pathogen indicators are covered by the combined pesticides products. Notably, the number of the generated application schemes may be limited generating only a predefined number of application schemes. In this respect, a generated application scheme may further comprise information about the dosage ranges for each pesticide product and thresholds, wherein the thresholds may be pre-defined or entered manually, and wherein the predefined thresholds may also be combined with a user defined variable threshold. The provided information about the dosage ranges for each pesticide product may also comprise different dosage ranges for each pesticide product in view of the crop growth stage and/or an infestation stage. In this respect, it is further preferred that an application scheme comprises mixture instructions about the dosage of the pesticide products and information about useful or required additives to the mixture. Thereby, a mixture of the pesticide products mentioned in an application scheme can be simplified and failures when mixing the pesticide products can be avoided, e.g. wrong mixing orders, too short stirring times and so on. Notably, the database search and/or the application schemes can be limited to preselected pesticide products. For example, a user may preselect pesticide products already available/stored such that these pesticide products can be used primarily.

In a step S70, the generated application schemes are ranked according to the number of pesticide products per application scheme, i.e. an application scheme requiring less pesticide products for covering all weed and/or pathogen indicators is ranked higher than an application scheme requiring more pesticide products. However, the ranking of the application schemes can additionally be based on additional information/requirements. In this respect, it is preferred that the step of ranking the generated application schemes is further based on the efficacy of the pesticide products against a weed and/or pathogen, the detrimental effects when mixing specific pesticide products, the efficacy of the pesticide products in view of crop growth stage or the sowing time, the past agricultural crop grown in the field and/or the next agricultural crop planned to be grown in the field, the efficacy of the pesticide products in view of the weed or pathogen growth stage, a treatment priority, the weather requirements for applying a pesticide product and/or the efficacy of the pesticide product in view of the weather data.

By the information with respect to the efficacy of the pesticide products against a weed and/or pathogen not only the number of pesticide products which are needed to cover all weed and/or pathogen specifiers can be used for ranking the generated application schemes, but also the efficacy of the pesticide products. The efficacies can be taken from commercial or public available databases and/or expert revisions, wherein if an expert revised efficacy is at hand, such data is preferred. Moreover, the efficacies can be weighted depending on the respective application, e.g. burn down, second burn down, around planting, emergence, harvesting. In this respect, efficacies may be either averaged across single efficacies and further weighted by the number of pesticide products in application scheme. By means of such a ranking the highest efficacy for each weed and/or pathogen specifier can be found potentially with a minimum number of pesticide products.

By the information with respect to potential detrimental effects when mixing specific pesticide products, pesticide product combinations having antagonistic effects can either be removed or listed at the end of the generated application schemes.

By the information with respect to the efficacy of the pesticide products in view of crop growth stage or the sowing time, a respective efficacy can be taken into account in view of the actual crop growth stage, e.g. seed, initial, juvenile, mature/flowering.

By the information with respect to the past agricultural crop grown in the field and/or the next agricultural crop planned to be grown in the field, the agricultural crop rotation can be considered when ranking the generated application schemes and a repeated application of the same pesticide product(s) or the same mode of action can be avoided. Therefore, combinations including a repeated application of pesticide products with the same mode of action and/or a repeated application of the same pesticide products can be a ranked lower, wherein a repeated application of the same pesticide products is ranked lower than a repeated mode of action for avoiding resistances.

By the information with respect to the efficacy of the pesticide products in view of the weed or pathogen growth stage, it is possible to further individualize an application scheme to the actual situation in the field. The information about the weed or pathogen growth stage can be provided by a user interface or by means of an image recognition of the respective field. Also here, the respective images can be provided by a satellite or a drone system. In addition, the information about the weed or pathogen growth stage can be provided by a third party, e.g. a service provider analyzing the respective images.

By the information with respect to a treatment priority, it can be indicated which weeds and/or pathogens can be exceptionally harmful for the agricultural crop and should be treated with priority. The priority information can be provided by a user interface or by means of an image recognition of the respective field. Also here, the respective images can be provided by a satellite or a drone system. In addition, the information about the treatment priority can be provided by a third party, e.g. a service provider analyzing the respective images.

In a step S80, a ranked list of application schemes is provided. However, outputting such a ranked list of application schemes is only optional. Based on the outputted ranked list, a user is could select one of the provided application schemes, which can be used for the further proceedings, e.g. for preparing a control data configured to be used in an agricultural equipment.

Finally, it is preferred that the method further comprises the step of generating control data configured to be used in an agricultural equipment, wherein the control data is based on the highest ranked application scheme or an application scheme selected by a user. For example, a user may select an application scheme depending on his own considerations or priorities by selecting a respective application scheme by respective inputting means of a data processing unit, e.g. a computer, a tablet, a smartphone or the like.

FIG. 2 is an exemplary schematic input screen by which a user may provide the information required for performing a method according to the present invention. As can be taken from FIG. 2, in this preferred embodiment, a sowing date and two application windows are provided, namely a sowing date of 1 Sep. 2018, a first application window between June 1 and August 12 and a second application window between August 12 and September 29. At the right hand side of the application windows, a respective weed species box is provided, in which actual or expected weed species can be included. At the lower area of the input screen, information about the crop, crop variety and the planned next crop has been selected by a user by means of a pull-down menu. Notably, an output screen (not shown) may visualize to a user an application scheme received according to a method shown in FIG. 1, wherein in such an output screen the allowed application times and potential residual times for each pesticide product may be visualized.

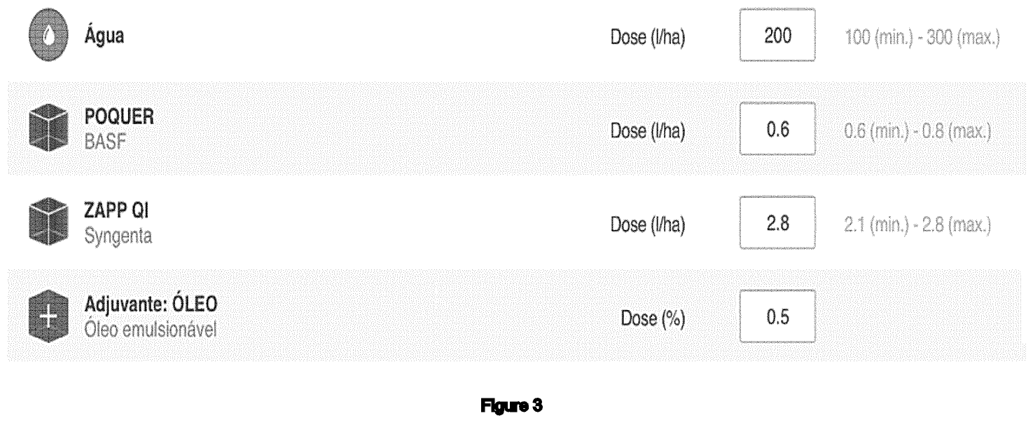

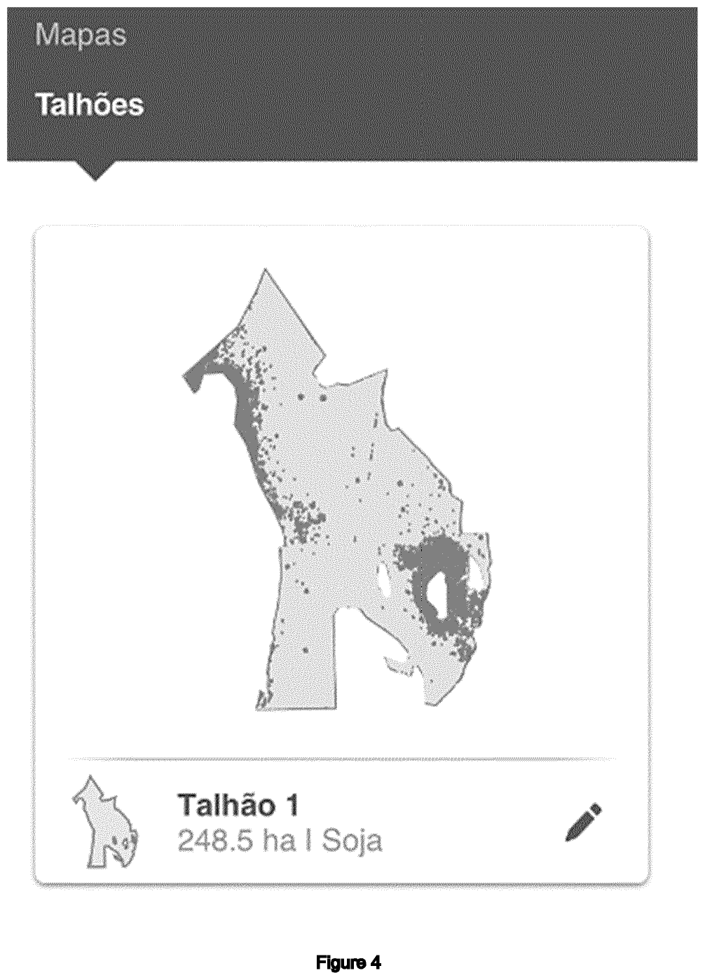

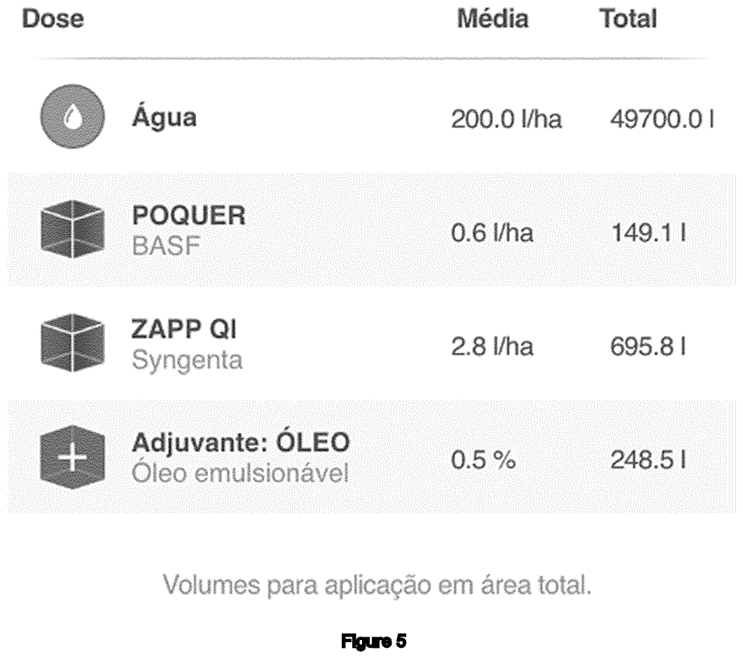

FIG. 3 is an exemplary schematic dose rate output scheme based on a recommended application scheme. FIG. 4 is an exemplary application map combining field data and an application scheme. The field data may comprise information about the geographical details, e.g. boundaries, and specifics of the field, the arrangement and the crop growth stage, and/or the distribution/position of the weeds and/or pathogens. By providing such field data and combining it with an application scheme, a spatially resolved application map can be provided comprising information about where and which dosage should be spread in the field. Notably, the field data can be provided by a user interface or by means of an image recognition of the respective field. Also here, the respective images can be provided by a satellite or a drone system. In addition, the field data can be provided by a third party, e.g. a service provider analyzing the respective images and application scheme. FIG. 5 shows an exemplary tank mix receipt for the field shown in FIG. 4.

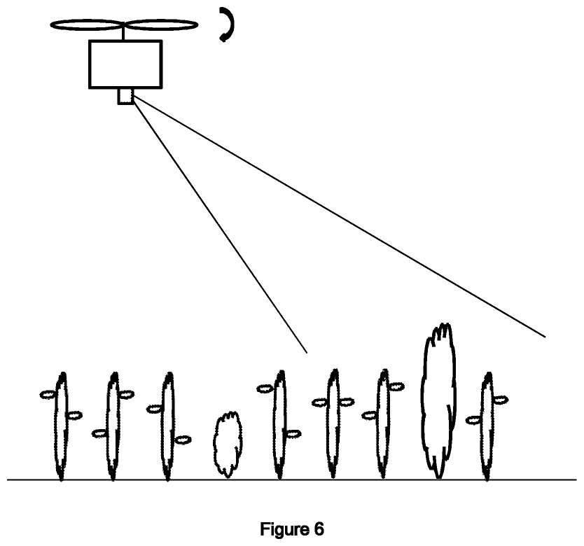

FIG. 6 shows an unmanned aerial vehicle (UAV), e.g. a drone, flying over a field containing a crop, which can be used for providing/acquiring the weed and/or pathogen specifier data. In the crop there may be a number of weeds/pathogens, two particular and different weed types are shown as an example in FIG. 6. One weed type, the taller weed shown in FIG. 6, is particularly virulent, produces numerous seeds and can significantly affect the crop yield. This weed should not be tolerated in the field containing this crop. However, it is also possible that a second type of weed shown in FIG. 6 as the shorter weed, can be beneficial to the overall biodiversity for the crop in the field, with the proviso that the number density of this weed per unit area is below a threshold value.

The UAV has a camera, and as it flies over the field imagery is acquired. The UAV also has a GPS and inertial navigation system, which enables both the position of the UAV to be determined and the orientation of the camera also to be determined. From this information the footprint of an image on the ground can be determined, such that particular parts in that image, such as the example of the first type of weed, can be located with respect to absolute geospatial coordinates. The image data acquired by the camera is preferably transferred to a processing unit external to the UAV. The processing unit image processes the images, using a machine learning algorithm based on an artificial neural network that has been trained on numerous image examples of different types of weeds, to determine if a weed is present and also to determine the type of weed. The processing unit then may utilize biodiversity settings, for this crop in this part of the world, and at the stage of its growth between seeding and harvesting. The biodiversity settings could be used by the processing unit to determine if specific weeds cannot be tolerated, or whether other specific weeds can be tolerated, and if so if there are any associated conditions, such as a threshold number density per unit area. For providing weed and/or pathogen specifier data comprising, the processing unit determines that all detected examples of the first weed type need to be destroyed.

The present invention has been described in conjunction with a preferred embodiment as examples as well. However, other variations can be understood and effected by those persons skilled in the art and practicing the claimed invention, from the studies of the drawings, this disclosure and the claims. Notably, in particular the steps S10 to S40 can be performed in any order, i.e. the present invention is not limited to a specific order of these steps. Moreover, it is also not required that the different steps are performed at a certain place or at one place, i.e. each of the steps may be performed at a different place using different equipment/data processing units. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

S10 providing agricultural crop data
S20 providing application time data
S30 providing weed and/or pathogen specifier data
S40 providing a pesticide product database
S50 performing a database search in the pesticide product database
S60 generating different application schemes
S70 ranking the generated application schemes
S80 providing a ranked list of application schemes

1. A method for determining and providing an application scheme for pesticides, the method comprising the following steps:
providing agricultural crop data (S10) comprising information about an agricultural crop species sown or planned to sow in a field;
providing application time data (S20) comprising information about at least one planned application time of applying pesticides in the field;
providing weed and/or pathogen specifier data (S30) comprising information about at least one weed or pathogen specifier present or expected in the field;
performing a database search in a pesticide product database (S50) at least based on the provided agricultural crop data, the provided application time data, the provided weed and/or pathogen specifier data and determining the pesticide products matching the agricultural crop and the application time and one of the weed or pathogen specifiers, wherein the pesticide product database comprises information about a plurality of pesticide products, and wherein the information about the pesticide products comprises at least information about an application area of each pesticide product, an active ingredient of each pesticide product and a suitable application time for each pesticide product; and
ranking generated application schemes (S70), wherein the different application schemes (S60) are generated by combining the determined pesticide products in such a way that all weeds and/or pathogen indicators are covered,
wherein the step of ranking is based on one or more of the following statistics per application scheme:
the number of pesticides per application scheme;
the number of leading or priority weeds and/or pathogens covered with an efficacy above a defined threshold, wherein in an example, the defined threshold is above 80% and wherein in an example this defined threshold represents the most weighted statistic per application scheme;
the number of all weeds and/or pathogens covered with an efficacy above a defined thresholds;
maximum efficacy achieved across weeds and/or pathogens by a given pesticide;
the fraction of pesticides in the application scheme of known preferred usage at the time of application;
the achieved efficacy sum of all pesticides in the application scheme for leading or priority weeds and/or pathogens;
the achieved efficacy sum of all pesticides in the application scheme for all weeds and/or pathogens;
if applicable, the average expected control of residual efficacy duration in soil; and/or
an index accounting for repeating the mode of action and/or active ingredient compared to previous applications.

2. The method according to claim 1, wherein the method further comprises the step of calculating statistics for each application scheme.

3. The method according to claim 1, wherein in a first step, the ranking is based on the number of all pathogens covered with a efficacy above a defined thresholds and the maximum efficacy achieved across pathogens by a given pesticide, wherein it is preferred that in a second step, the ranking is further specified in view of or based on one or more of the following statistics per application scheme:
a) the number of pesticides per application scheme;
b) maximum efficacy achieved across pathogens by a given pesticide;
c) the fraction of pesticides in the application scheme of known preferred usage at the time of application;
d) the achieved efficacy sum of all pesticides in the application scheme for leading or priority pathogens;
e) the achieved efficacy sum of all pesticides in the application scheme for all pathogens;
f) if applicable, the average expected control of residual efficacy duration in soil; and/or
g) an index accounting for repeating the mode of action and/or active ingredient compared to previous applications.

4. The method according to claim 1, wherein the agricultural crop data is provided by means of a user interface or by a data processing unit.

5. The method according to claim 1, wherein the weed and/or pathogen specifier is provided by means of a user interface or by means of an image recognition of the field.

6. The method according to claim 1, wherein an application scheme further comprises information about the dosage ranges for each pesticide product and thresholds.

7. The method according to claim 1, wherein the method further comprises the step of providing an application map by combining field data and an application scheme.

8. The method according to claim 1, wherein:
the pesticide product information further comprises information about the efficacy of the pesticide products against a weed and/or pathogen; and
the step of ranking the generated application schemes is further based on the efficacy of the pesticide products against a weed and/or pathogen.

9. The method according to claim 1, wherein:
the pesticide product information further comprises information about detrimental effects when mixing specific pesticide products; and
the step of ranking the generated application schemes is further based on the detrimental effects when mixing specific pesticide products.

10. The method according to claim 1, wherein:
the provided agricultural crop data further comprises information about the crop growth stage or the sowing date; and
the pesticide product information further comprises information about the efficacy of the pesticide products in view of crop growth stage or the sowing date; and
the step of ranking the generated application schemes is further based on the efficacy of the pesticide products in view of crop growth stage or the sowing time.

11. The method according to claim 1, wherein:
the provided agricultural crop data further comprises information about the past agricultural crop grown in the field and/or the next agricultural crop planned to be grown in the field; and
the step of ranking the generated application schemes is further based on information about the past agricultural crop grown in the field and/or the next agricultural crop planned to be grown in the field.

12. The method according to claim 1, wherein:
the weed and/or the pathogen specifier data further comprises information about the weed or pathogen growth stage; and
the pesticide product information further comprises information about the efficacy in view of the weed or pathogen growth stage; and
the step of ranking the generated application schemes is further based on the efficacy of the pesticide products in view of the weed or pathogen growth stage.

13. The method according to claim 1, wherein:
the weed and/or pathogen specifier data further comprises information about a treatment priority; and
the step of ranking the generated application schemes is further based on the information about the treatment priority.

14. The method according to claim 1, wherein the database search and/or the application schemes are limited to preselected pesticide products.

15. The method according to claim 1, wherein an application scheme comprises mixture instructions about the dosage of the pesticide products and information about useful or required additives to the mixture.

16. The method according to claim 1, wherein the method further comprises the step of generating control data configured to be used in an agricultural equipment, wherein the control data is based on the highest ranked application scheme or an application scheme selected by a user.

17. Use of an application scheme received according to a method according to claim 1 for providing control data for controlling an agricultural equipment.

18. Use of a pesticide product database in a method according to claim 1, wherein the pesticide product database comprising information about a plurality of pesticide products, and wherein the information about the pesticide products comprises at least information about an application area of each pesticide product, an active ingredient of each pesticide product and a suitable application time for each pesticide product.

19. A system for determining and providing an application scheme for pesticides, the system comprising:
at least one interface for providing agricultural crop data, a weed and/or pathogen specifier and application time data;
at least one memory unit comprising a pesticide product database comprising information about a plurality of pesticide products, and wherein the information about the pesticide products comprises at least information about an application area of each pesticide product, an active ingredient of each pesticide product and a suitable application time for each pesticide product;
at least one processing unit configured to perform a database search in the pesticide product database at least based on the provided agricultural crop data, the provided application time data, the provided weed and/or pathogen specifier data and which determines the pesticide products matching the agricultural crop and the application time and one of the weed or pathogen specifiers;
at least on processing unit configured to generate different application schemes by combining the determined pesticide products in such a way that all weeds and/or pathogen indicators are covered; and
at least one processing unit configured to rank the generated application schemes at least according to the number of pesticide products per application scheme.

20. A non-transitory, computer-readable medium having instructions encoded thereon which when executed by a processor causes the processor to carry out the method of claim 1.
